(19) United States
(12) Patent Application Publication
(10) Pub. No.: US 2011/0298717 A1
(43) Pub. Date: Dec. 8, 2011

(54) KEYBOARD WITH REPLACEABLE LAYOUT SHEET

(75) Inventor: YUNG-LUNG LIU, Ta Ya Shiang (TW)

(73) Assignee: Sunrex Technology Corp., Ta Ya Shiang (TW)

(21) Appl. No.: 12/796,246

(22) Filed: Jun. 8, 2010

(51) Int. Cl. G06F 3/02

(52) U.S. Cl. 345/168

(57) ABSTRACT

A keyboard includes a key housing, a rectangular membrane circuit board, a rectangular layout sheet releasably secured on top of the membrane circuit board and comprising a plurality of keys each printed with a letter of alphabet, a numerical digit, a punctuation symbol, or a function number designation, and a base plate. The layout sheet can be labeled in English, German, Spanish, or one of other different languages.

### BACKGROUND OF THE INVENTION

1. Field of Invention

The invention relates to keyboard layouts and more particularly to a computer keyboard having a layout sheet which can be replaced by another layout sheet having a keyboard layout used for a different language if such need arises.

2. Description of Related Art

Keyboards are the most popular computer input devices despite the availability of mouse, trackball, touchscreen, etc. Currently, there are many different keyboard layouts in the worlds due to different languages. For example, US and Chinese (Traditional) keyboards are used in Taiwan. Further, there are, for example, Spanish, French, and German keyboard layouts.

Typically, the letters of alphabet, numerical digits, and various extra keys are permanently printed on keycaps of a keyboard (e.g., US keyboard). However, an individual traveling to Spain and bringing, for example a laptop, may find it somewhat difficult or inconvenient if he or she wants to use the laptop for keyboarding because the keyboard layout of the laptop is designed for American-English. Moreover, as far as the present inventor is aware, there are no documents disclosing a computer keyboard having a layout sheet which can be replaced by another layout sheet having a keyboard layout used for a different language if such need arises. Thus, the need for improvement still exists.

### SUMMARY OF THE INVENTION

It is therefore one object of the invention to provide a keyboard comprising a key housing, a rectangular membrane circuit board, a rectangular layout sheet releasably secured on top of the membrane circuit board and comprising a plurality of keys each printed with a letter of alphabet, a numerical digit, a punctuation symbol, or a function number designation, and a base plate. The layout sheet can be labeled in English, German, Spanish, or one of other different languages.

The above and other objects, features and advantages of the invention will become apparent from the following detailed description taken with the accompanying drawings.

### BRIEF DESCRIPTION OF THE DRAWINGS

FIG. 1 is a perspective view of a keyboard according to the invention;

FIG. 2 is an exploded view of the keyboard shown in FIG. 1;

FIG. 3 is another exploded view of the keyboard shown in FIG. 1 with the key housing removed; and

FIG. 4 is a longitudinal sectional view of the keyboard shown in FIG. 1 with the key housing removed and finger tip pressing a key.

### DETAILED DESCRIPTION OF THE INVENTION

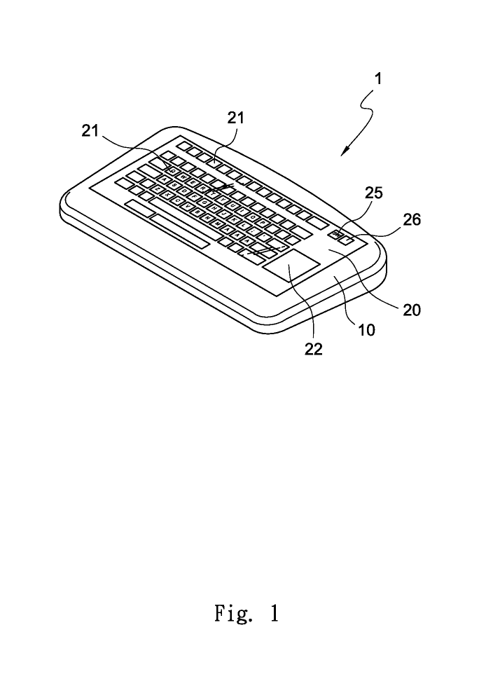

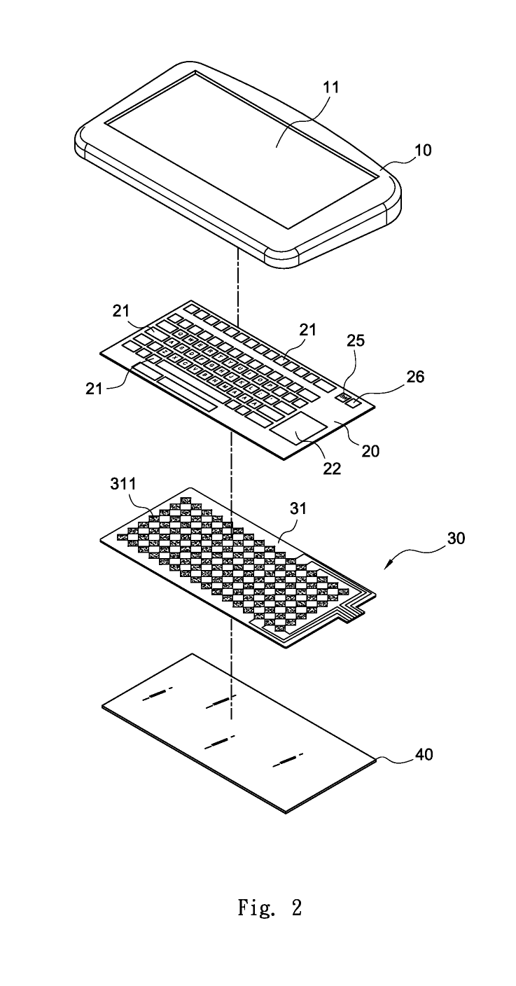

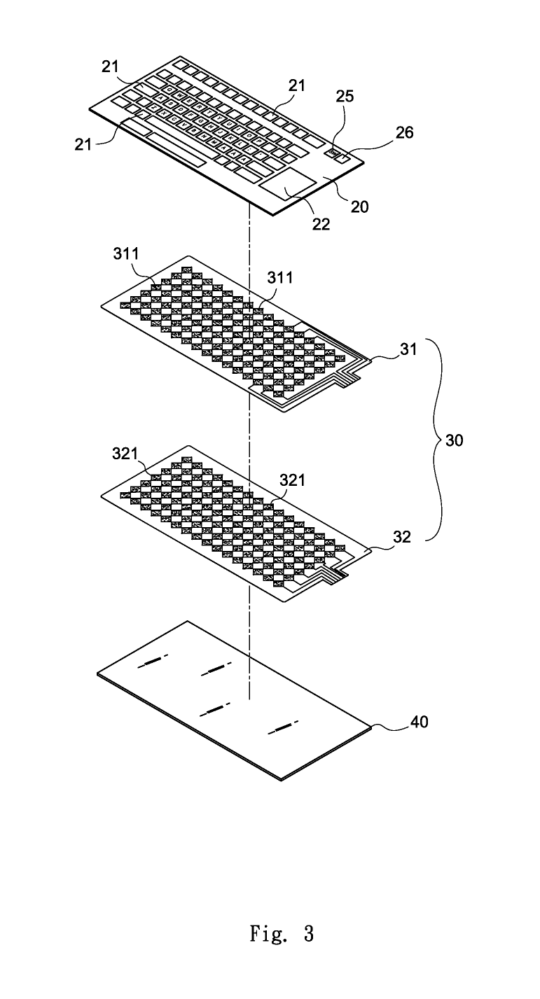

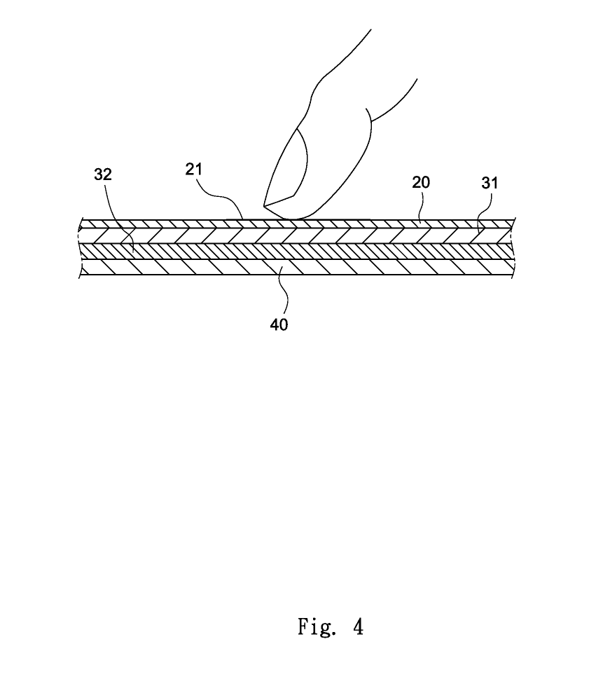

Referring to FIGS. 1 to 4, a keyboard 1 in accordance with the invention comprises the following components as discussed in detail below.

A substantially rectangular key housing 10 has a rectangular opening 11 defined therein. A rectangular layout sheet 20 is shaped to fit in the opening 11 and is made of thermoplastics (i.e., flexible). The layout sheet 20 comprises, on a top surface, a plurality of keys 21 printed with the letters of alphabet, numerical digits, punctuation symbols, and various function number designations. The keys 21 can be labeled in, for example, English, Spanish, or German so as to suit the needs of different language users. The layout sheet 20 further comprises a touchpad 22 at the right and first and second switches 25, 26 at the right top corner. The touchpad 22 is provided for finger sliding thereon so as to simulate the operation of a mouse. A user may press the first switch 25 to switch the keyboard 1 to a typing mode or the second switch 26 to switch to the keyboard 1 to a touchpad operation mode.

A rectangular membrane circuit board 30 is shaped to dispose below and engage with a bottom surface of the layout sheet 20. The membrane circuit board 30 is either capacitive (as in this embodiment) or resistive. The membrane circuit board 30 comprises an upper first conductive layer 31 being flexible, the first conductive layer 31 including a plurality of first sensor zones 311 each corresponding to a key 21 thereon. The first sensor zones 311 are coated with metal conductor. The membrane circuit board 30 further comprises a lower second conductive layer 32 being flexible, the second conductive layer 32 including a plurality of second sensor zones 321 each corresponding to the first sensor zone 311 thereon. The second sensor zones 321 are also coated with metal conductor.

A rectangular base plate 40 is shaped to dispose below and engage with a bottom surface of the membrane circuit board 30. The base plate 40 is adapted to secure to the key housing 10 to assemble a complete keyboard 1 with the layout sheet 20 being exposed on top and the membrane circuit board 30 being hidden.

For typing, a user may press the first switch 25 to switch the keyboard 1 to the typing mode. Then the user may use his or her finger to press the key 21 so as to change capacitance between the layout sheet 20 and the membrane circuit board 30 (i.e., both the first conductive layer 31 and the second conductive layer 32). As such, a corresponding key press signal is generated.

For operating the touchpad 22, the user may press the second switch 26 to switch to the touchpad operation mode. Then the user may slide his or her finger on the touchpad 22 so as to change capacitance between the layout sheet 20 and the membrane circuit board 30 (i.e., both the first conductive layer 31 and the second conductive layer 32). As such, a corresponding mouse drag signal is generated.

The subject of the invention is that the layout sheet 20 is releasably fastened on the membrane circuit board 30 by, for example, pressure sensitive adhesive. Hence, for example, an American traveling to Spain and bringing a keyboard 1 of the invention can easily replace the layout sheet 20 of US layout with a layout sheet 20 of Spanish layout if he or she wants to use the keyboard 1 in Spain. The cost of buying the layout sheet 20 is much less than that of buying a keyboard. Hence, it is cost effective.

While the invention has been described in terms of preferred embodiments, those skilled in the art will recognize that the invention can be practiced with modifications within the spirit and scope of the appended claims.

What is claimed is:

1. A computer keyboard comprising:
a rectangular membrane circuit board; and
a rectangular layout sheet releasably secured on top of the membrane circuit board and comprising a plurality of keys each printed with a letter of alphabet, a numerical digit, a punctuation symbol, or a function number designation.

2. The computer keyboard of claim 1, wherein the layout sheet further comprises first and second switches, and wherein a press of the first switch switches the keyboard to a typing mode or a press of the second switch switches the keyboard to a touchpad operation mode.

3. The computer keyboard of claim 1, wherein the layout sheet further comprises a touchpad for finger sliding thereon so as to simulate operations of a computer mouse.

4. The computer keyboard of claim 1, further comprising a key housing and a base plate adapted to secure to the key housing to assemble a complete computer keyboard with the layout sheet being exposed on top of the computer keyboard and the membrane circuit board being hidden.

5. The computer keyboard of claim 1, wherein the membrane circuit board is capacitive.

6. The computer keyboard of claim 1, wherein the membrane circuit board is resistive.

7. The computer keyboard of claim 5, wherein the membrane circuit board comprises an upper flexible first conductive layer, the first conductive layer including a plurality of first sensor zones each corresponding to the key thereon, the first sensor zones coated with metal conductor; and a lower flexible second conductive layer including a plurality of second sensor zones each corresponding to the first sensor zone thereon, the second sensor zones coated with metal conductor.

8. The computer keyboard of claim 1, wherein a press of the key changes capacitance between the layout sheet and the membrane circuit board for generating a corresponding key press signal.
